(19) United States
(12) Patent Application Publication
(10) Pub. No.: US 2026/0007119 A1
(43) Pub. Date: Jan. 8, 2026

(54) Pest Deterrent Roller Guard for Animal Feed Dispenser

(71) Applicant: Double Down Deer Feed, LLC, Rosenberg, TX (US)

(72) Inventor: Brett Marshall Holden, Richmond, TX (US)

(21) Appl. No.: 19/258,289

(22) Filed: Jul. 2, 2025

Related U.S. Application Data
(60) Provisional application No. 63/667,041, filed on Jul. 2, 2024.

(51) Int. Cl. A01K 5/02

(52) U.S. Cl. CPC A01K 5/0225

(57) ABSTRACT

The present invention generally relates to devices and methods to prevent intrusion by varmint, rodent, pests, and unintended wildlife into animal feed dispensers. Particularly, the inclusion of roller guards near or at the points where animal feed is dispensed from the animal feed dispenser reduces, limits, and/or eliminates waste and consumption of the animal feed by varmints, rodents, pests, and/or other unintended wildlife. The feed typically used to attract intended wildlife is purchased at a cost and when the feed is eaten by animals other than the intended wildlife costs of restocking the animal feed dispensers are borne by the hunter, rancher, or farmer. Further, feeding unintended wildlife can create interspecies dependency, such as racoons, opossums, and other wildlife living and surviving off feed intended for deer or other animals instead of foraging and hunting for their own food sources.

### CROSS-REFERENCE TO RELATED APPLICATIONS

This application claims priority to U.S. Provisional Patent Application 63/667,041, filed on Jul. 2, 2024.

### STATEMENT REGARDING FEDERALLY SPONSORED RESEARCH

Not applicable.

### BACKGROUND

The present invention generally relates to devices and methods to prevent intrusion by varmint, rodent, pests, and unintended wildlife into animal feed dispensers. Particularly, the inclusion of roller guards near or at the points where animal feed is dispensed from the animal feed dispenser reduces, limits, and/or eliminates waste and consumption of the animal feed by varmints, rodents, pests, and/or other unintended wildlife.

Wildlife enthusiasts, including hunters, zookeepers, farmers, ranchers, game wardens, and others, often use feed to attract wildlife, such as deer. Enthusiasts may distribute animal feed in a specific location to attract a variety of wildlife. For example, bird watchers may distribute a variety of seed in a bird feeder or on the ground to attract birds. As a further example, hunters may distribute corn feed through a feeder or by hand on the ground at or near the location the hunter intends to hunt the deer that come to the feed.

Hunters, farmers, and ranchers often desire animal feed products that are more attractive to certain wildlife and livestock animals. Additionally, they also desire animal feed products that will provide nutrients to assist the game animals or livestock in producing better meat, antlers, offspring, or generally providing for better quality growth and health of the animal. Some hunters, herd managers, or property owners also desire to use attractants to entice game animals on to their property or keep animals on their property for hunting or herd management. The feed typically used to attract intended wildlife is purchased at a cost and when the feed is eaten by animals other than the intended wildlife costs of restocking the animal feed dispensers are borne by the hunter, rancher, or farmer. Further, feeding unintended wildlife can create interspecies dependency, such as racoons, opossums, and other wildlife living and surviving off feed intended for deer or other animals instead of foraging and hunting for their own food sources. Further, intrusion into the feed dispensers by unintended wildlife can damage the feed dispensers causing the feed to not dispense properly, meaning deer are no longer getting their feed or supplements, and/or damage to the dispenser requiring costly repairs or replacement. There is a long-felt need for a device to prevent such intrusions by unintended wildlife into and/or on animal feed dispensers that is answered by the present invention.

### SUMMARY

In some embodiments, the present invention is a device including roller guards for installation on or around animal feed dispenser egress points. The roller guards operate in a manner that does not allow the unintended wildlife to obtain a sufficient grip, foot/paw hold, or cause the unintended wildlife to slip off of the animal feed dispenser when attempting to intrude into the feed dispenser egress points or on or around the dispenser.

### BRIEF DESCRIPTION OF THE DRAWINGS

For a more complete understanding of the present disclosure and the advantages thereof, reference is now made to the following descriptions to be taken in conjunction with the accompanying figures describing specific embodiments of the disclosure, wherein:

FIG. 1A illustrates an embodiment of the roller guard.

FIG. 1B illustrates an alternative embodiment of the roller guard.

FIG. 1C illustrates an alternative embodiment of the roller guard.

FIG. 2 illustrates an embodiment of the roller guard installed on an animal feed dispenser.

FIG. 3 illustrates an embodiment of the roller guard installed on a trough style animal feed dispenser.

FIG. 4 illustrates an embodiment of the roller guard installed across support members of the frame of the animal feed dispenser.

### DETAILED DESCRIPTION

One or more illustrative embodiments incorporating the invention disclosed herein are presented below. In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the figures in general, it will be understood that the illustrations are for the purpose of describing embodiments of the disclosure and are not intended to be limiting thereto. Figures are not necessarily to scale, and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. Definitions and/or interpretations should not be incorporated from other patent applications, patents, or publications, related or not, unless specifically stated in this specification, or if the incorporation is necessary for maintaining validity.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

The present invention relates to the use of roller guards on or around animal feed dispensers to prevent or abate unwanted animals from accessing the animal feed egress points also known as feeder tubes and/or intrusion into the dispenser itself. Such intrusions may cause damage such as preventing feed from dispensing properly causing feed rot or necessitating repair or replacement of parts or the feed dispenser itself. The present invention can be used with all animal feed dispensers such as: spincast, tube, trough, ring, and/or broadcast dispensers. The present invention can be used in conjunction with all sizes and shapes of feeder tubes and dispensers.

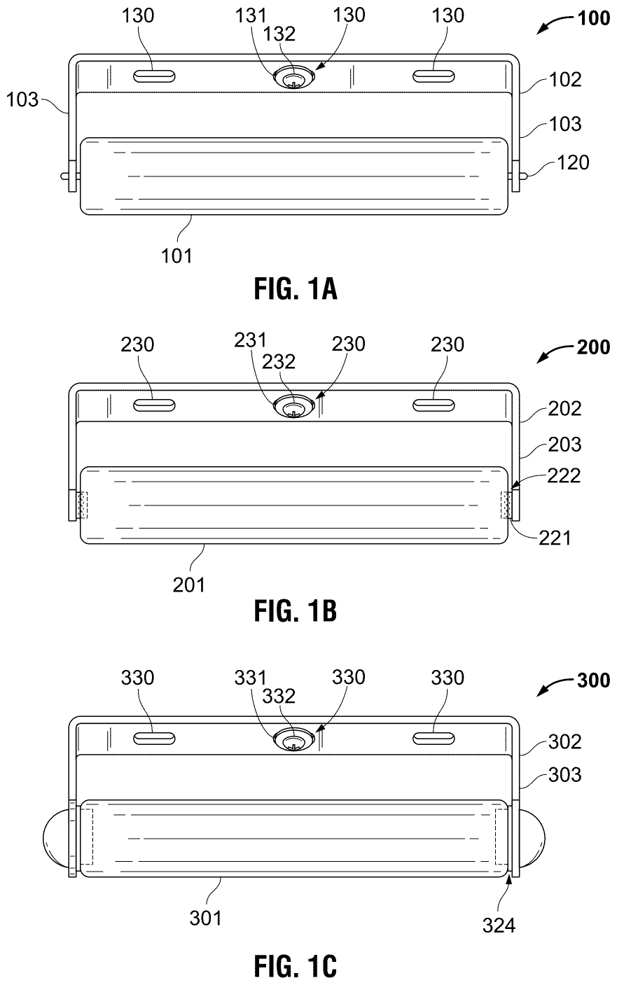

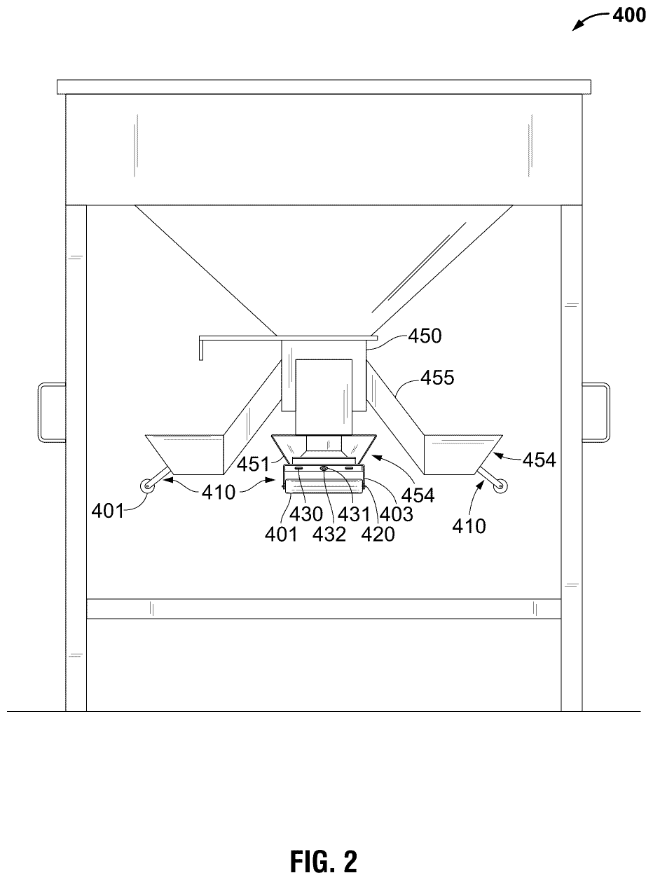

FIG. 1A shows an embodiment a roller guard 100 having a roller 101 and bracket 102 with arms 103. The roller 101 may be comprised of a cylindrical tube, preferably having a smooth surface to prevent an animal from gripping the roller and additionally provide rotational movement to cause animals to not stand or grab the roller and causing falling or expulsion of the animal from the feed dispenser. The bracket 102 includes arms 103 protruding away from the main body of the bracket. The arms 103 may include cavities for receiving a pin 120, wherein the pin may protrude from both ends of the roller 101 or may comprise a rod or pin that traverses the length of the roller for installation on to the bracket arms 103. The pins 120 allow for rotational movement of the roller 101 about an axis formed by said pins. The bracket 102 may also include mounting holes 130 for affixing the bracket to an animal feed dispenser, such as those shown in FIGS. 2, 3, and 4. The bracket may be affixed to the animal feed dispenser with a washer 131 and fastener 132, such as a bolt or screw. The bracket may also be affixed or attached to the animal feed dispenser through clamps, clips, press fit connections, and other means of affixing or attaching known in the art. FIG. 1B shows an embodiment a roller guard 200 having a roller 201, bracket 202 with arms 203. The roller 201 may be comprised of a cylindrical tube, preferably having a smooth surface to prevent an animal from gripping the roller and additionally provide rotational movement to cause animals to not stand or grab the roller and causing falling or expulsion of the animal from the feed dispenser. The bracket 202 includes arms 203 protruding away from the main body of the bracket. The arms 203 may include cavities 221 for receiving a ball bearing fitting 221, wherein the ball bearing fitting may protrude from both ends of the roller 201 allowing for rotational movement of the roller 201 about an axis formed by the ball bearing fittings. In some embodiments, the ball bearing fitting 221 may be press fitted into both the roller 201 and the cavity 221 to allow for rotation of the roller 201. The bracket 202 may also include mounting holes 230 for affixing the bracket to an animal feed dispenser, such as those shown in FIGS. 2, 3, and 4. The bracket may be affixed to the animal feed dispenser with a washer 231 and fastener 232, such as a bolt or screw. The bracket may also be affixed or attached to the animal feed dispenser through clamps, clips, press fit connections, and other means of affixing or attaching known in the art.

FIG. 1C shows an embodiment a roller guard 300 having a roller 301, bracket 302 with arms 303. The roller 301 may be comprised of a cylindrical tube, preferably having a smooth surface to prevent an animal from gripping the roller and additionally provide rotational movement to cause animals to not stand or grab the roller and causing falling or expulsion of the animal from the feed dispenser. The bracket 302 includes arms 303 protruding away from the main body of the bracket. The arms 303 may include circular pegs 324 for fitting into a cavity formed on one or both ends of the cylindrical roller 301. Such configuration allows for rotational movement of the roller 301 about the pegs 324. The bracket 302 may also include mounting holes 330 for affixing the bracket to an animal feed dispenser, such as those shown in FIGS. 2, 3, and 4. The bracket may be affixed to the animal feed dispenser with a washer 331 and fastener 332, such as a bolt or screw. The bracket may also be affixed or attached to the animal feed dispenser through clamps, clips, press fit connections, and other means of affixing or attaching known in the art.

FIG. 2 shows an embodiment of an animal feed dispenser 400 with several roller guards 410 affixed to animal feed egress points 454 of the feeder tube 455 which are attached to the feed dispenser mechanism 450. Also shown are horizontal support members 457 and vertical support members 458 for supporting animal feed dispenser 400. The roller guard 410 can be installed below or in front of the feeder tube 455 or on an edge 451 of the egress point 454. The roller 401 can be installed within a bracket 402, having arms 403, wherein the bracket can be attached to the feeder tube via a mounting holes 430, washer/fastener 431/432, a plurality of fasteners, clips, slidable engagements, pins, welds, adhesives, or other attachment means known in the art or discussed herein. In some embodiments, the roller guard can be built into or extend from the feed tube. The arms 403 may include cavities for receiving a pin 420, wherein the pin may protrude from both ends of the roller 401 or may comprise a rod or pin that traverses the length of the roller for installation on to the bracket arms 403. The pins 420 allow for rotational movement of the roller 401 about an axis formed by said pins. In other embodiments, the roller guard can be purchased as an add-on to install on pre-existing animal feed dispensers through a retrofit or adapter installation kit. It should be appreciated that any embodiment of the roller guard, disclosed herein, can be mounted or installed onto such animal feed dispensers.

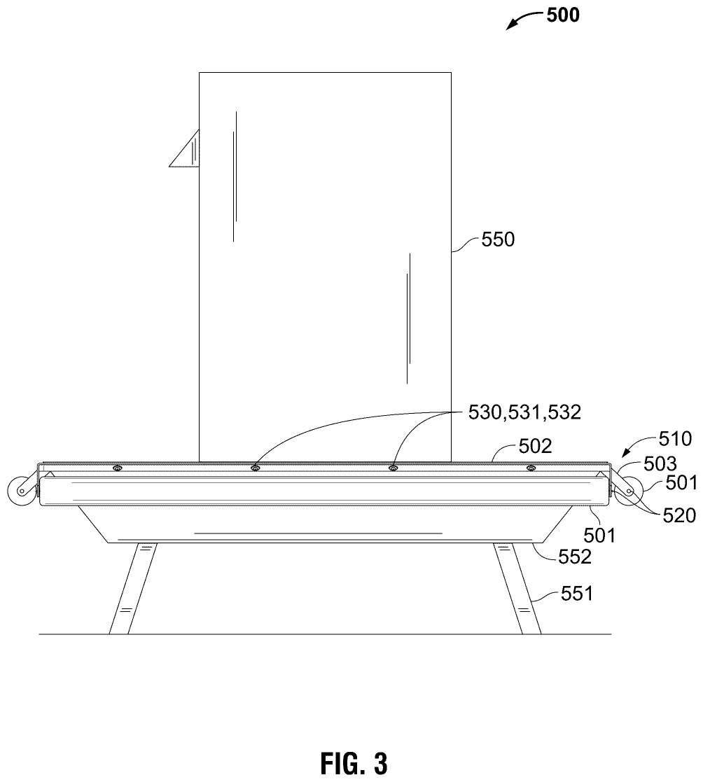

FIG. 3 shows an alternative embodiment of an animal feed dispenser 500, commonly known as a trough feeder, with several roller guards 510 affixed to the troughs 552. Also shown support members 551 for supporting animal feed dispenser 500 having a feed holder 550. The roller guard 501 can be installed below or in front of the trough 552 or on an edge. The roller guard 501 can be installed within a bracket 502 having arms 503 and mounting holes 530 wherein the bracket can be attached to the trough via a fastener 531/532, plurality of fasteners, clips, slidable engagements, pins, welds, adhesives, or other attachment means known in the art or discussed herein. The arms 503 may include cavities for receiving a pin 520, wherein the pin may protrude from both ends of the roller 501 or may comprise a rod or pin that traverses the length of the roller for installation on to the bracket arms 503. The pins 520 allow for rotational movement of the roller 501 about an axis formed by said pins. In some embodiments, the roller guard can be built into or extend from the edge of the trough. In other embodiments, the roller guard can be purchased as an add-on to install on pre-existing animal feed dispensers through a retrofit or adapter installation kit.

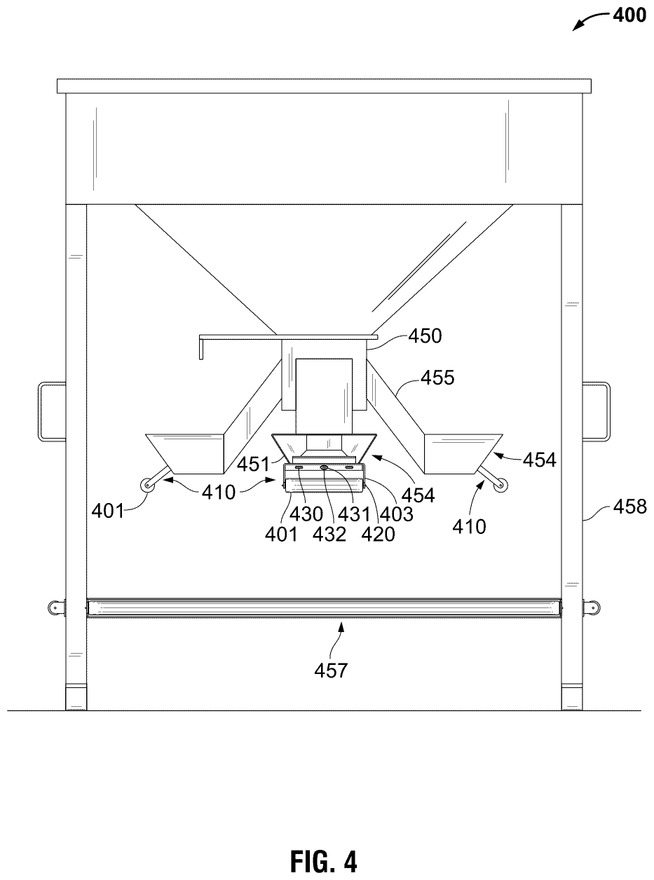

FIG. 4 shows an alternate embodiment of an animal feed dispenser 400 of FIG. 2 with several roller guards 410 affixed to animal feed egress points 454 of the feeder tube 455 which are attached to the feed dispenser mechanism 450. Also shown are horizontal support member 457 and vertical support member 458 for supporting animal feed dispenser 400. Also shown are roller guards mounted across the horizontal support member 457. The inclusion of roller guards across the horizontal support members can help prevent further intrusion by animals into or on the animal feed dispenser. The roller guard 401 can be installed below or in front of the feeder tube 455 or on an edge 451 of the egress point 454. The roller guard 401 can be installed within a bracket 402 having mounting holes 430 wherein the bracket can be attached to the feeder tube via a fastener 431/432, plurality of fasteners, clips, slidable engagements, pins, welds, adhesives, or other attachment means known in the art or discussed herein. In some embodiments, the roller guard can be built into or extend from the feed tube. In other embodiments, the roller guard can be purchased as an add-on to install on pre-existing animal feed dispensers through a retrofit or adapter installation kit.

It should be appreciated that the roller guards disclosed and claimed herein can be mounted at multiple different places on or about animal feed dispensers to prevent waste of animal feed by unwarranted species. This can include, but not limited to, the tops, sides, bottom, access panels, support legs, cross members of the animal feed dispensers.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

What is claimed is the following:

1. An animal feed dispenser comprising:
a feed tank;
a feed dispenser operatively connected to the feed tank;
a feed chute for distributing feed dispensed by the feed dispenser from the feed tank, wherein said feed chute has an egress cavity for dispensed feed to exit having at least an edge about the egress cavity; and
a roller guard comprising a bracket mounted to said feed chute egress cavity.

2. The animal feed dispenser of claim 1 wherein the roller guard further comprises a cylindrical body having one or more pins extend away from and long a longitudinal axis of the cylindrical body, wherein said one or more pins matingly engages with a receiving cavity formed on at least one arm of said bracket.

3. The animal feed dispenser of claim 2 wherein the roller guard further comprises one or more ball bearing fittings affixed to an internal surface of said cylindrical body and wherein said one or more pins extends through said ball bearings providing an axis of rotation about the one or more pins.

4. The animal feed dispenser of claim 1 wherein the roller guard further comprises a cylindrical body having a hollow, internal cavity formed through and along the longitudinal axis of the cylindrical body, and wherein the bracket further comprises a second arm, wherein the first and second arms further comprise opposing pins projecting inwards for receiving at least a portion of the internal cavity formed through and along the longitudinal axis of the cylindrical body.

5. A roller guard for deterring animals from intruding into an animal feed dispenser comprising:
a bracket comprising an arm, wherein the arm has a cavity, formed through said arm, for receiving a pin;
a cylindrical roller mounted to said arm via insertion of the pin through said cavity, wherein the cylindrical roller comprises a smooth surface and rotation movement about an axis formed by said pin.

6. The roller guard of claim 5 wherein the roller guard further comprises a second arm, wherein the second arm has a cavity, formed through said arm, for receiving the pin, wherein said cylindrical roller is mounted between the first and second arms.

7. The roller guard of claim 6 wherein the pin is a single rod extending through a length of the cylindrical roller.

8. The roller guard of claim 6 wherein the pin a plurality of pins, wherein each pin extends from a distal end of the cylindrical roller.

9. The roller guard of claim 5 wherein the bracket further comprises one or more mounting holes for affixing the bracket to an animal feed dispenser.

10. The roller guard of claim 7 wherein the bracket further comprises one or more mounting holes for affixing the bracket to an animal feed dispenser.

11. The roller guard of claim 8 wherein the bracket further comprises one or more mounting holes for affixing the bracket to an animal feed dispenser.

12. An animal feed dispenser comprising:
a feed tank;
a feed dispenser operatively connected to the feed tank;
a feed trough for distributing and holding feed from the feed dispenser for use by intended animals, wherein said feed trough comprises an edge;
a bracket affixed to the edge of said feed trough; wherein the bracket comprises one or more arms having a cavity formed therethrough for receiving a pin;
a cylindrical roller having a pin extend from a distal end of said cylindrical roller mounted via the pin to said bracket arm, wherein the cylindrical roller provides a rotational movement about an axis formed by said pin.
